(19) United States
(12) Patent Application Publication
(10) Pub. No.: US 2023/0290273 A1
(43) Pub. Date: Sep. 14, 2023

(54) COMPUTER VISION METHODS AND SYSTEMS FOR SIGN LANGUAGE TO TEXT/SPEECH

(71) Applicants: Arihan Pande Yadav, Cupertino, CA (US); Aarush Pande Yadav, Cupertino, CA (US)

(72) Inventors: Arihan Pande Yadav, Cupertino, CA (US); Aarush Pande Yadav, Cupertino, CA (US)

(21) Appl. No.: 17/865,379

(22) Filed: Jul. 14, 2022

Related U.S. Application Data
(60) Provisional application No. 63/317,871, filed on Mar. 8, 2022.

(51) Int. Cl. G09B 21/00; G09B 21/04; G06V 40/20; G10L 13/00

(52) U.S. Cl. CPC G09B 21/009; G09B 21/04; G06V 40/28; G10L 13/00

(57) ABSTRACT

A method for converting a digital image comprising a sign-language sign to a text or computer-generated speech: obtaining a web camera stream of a sign-language sign; breaking down the one or more digital video images into a set of singular frames; for each singular frame of the set of singular frames, convert the digital image in the singular frame to an imaging library image; providing a machine-learned model; feeding the digital image into the machine-learned model; adding a sequential layer onto the machine-learned model, wherein the sequential layer comprises a first linear drop model to prevent loss from increasing throughout a training process, and wherein the sequential layer comprises a second linear model used to reduce a loss down to a specified number of output classes; for each digital image: resizing the digital image to two-hundred and twenty-four (224) by two-hundred and twenty-four (224) pixels, scaling down the digital image, removing each border of the digital image, and randomly rotating the digital image to create a modified digital image; inputting the modified digital image input into a tensor; and using the tensor to train the machine-learning model to recognize the sign-language sign.

### CLAIM OF PRIORITY

This application claims priority to U.S. Provisional Patent Application No. 63/317,871, filed on 8 Mar. 2022, and titled UNIVERSAL MESSAGING METHODS AND SYSTEMS. This provisional patent application is hereby incorporated by reference in its entirety.

### SUMMARY OF THE INVENTION

A method for converting a digital image comprising a sign-language sign to a text or computer-generated speech: obtaining a web camera stream of a sign-language sign; breaking down the one or more digital video images into a set of singular frames; for each singular frame of the set of singular frames, convert the digital image in the singular frame to an imaging library image; providing a machine-learned model; feeding the digital image into the machine-learned model; adding a sequential layer onto the machine-learned model, wherein the sequential layer comprises a first linear drop model to prevent loss from increasing throughout a training process, and wherein the sequential layer comprises a second linear model used to reduce a loss down to a specified number of output classes; for each digital image: resizing the digital image to two-hundred and twenty-four (224) by two-hundred and twenty-four (224) pixels, scaling down the digital image, removing each border of the digital image, and randomly rotating the digital image to create a modified digital image; inputting the modified digital image input into a tensor; and using the tensor to train the machine-learning model to recognize the sign-language sign.

### BACKGROUND

During video telephony calls, mute people may not be able to project their voice Sign language is more efficient and faster than just typing but if they use sign language then other users may not be able to understand. Additionally, other users must continuously watch the computer screen to view the signing user. If they use a chat functionality, it can be time consuming and limit their ability to fully express themselves. Accordingly, a functionality that enables a computer to interpret sign language and convert it to text and/or speech so that everyone could have a voice is desired.

### BRIEF DESCRIPTION OF THE DRAWINGS

The present application can be best understood by reference to the following description taken in conjunction with the accompanying figures, in which like parts may be referred to by like numerals.

FIGS. 1A-B illustrate an example process for computer vision sign language to text/speech, according to some embodiments.

FIG. 2 illustrates an example process for using dynamic programming to optimize the machine-learning model, according to some embodiments.

FIG. 3 illustrates an example process for computer vision operations, according to some embodiments.

FIG. 4 illustrates an example process for converting modified digital image(s) into a probability value that the images represent a specified sign, according to some embodiments.

FIG. 5 illustrates an example processing of utilizing plots to show the improvement in the accuracy of a machine learning mode over time, according to some embodiments.

The Figures described above are a representative set and are not an exhaustive with respect to embodying the invention.

### DESCRIPTION

Disclosed are a system, method, and article of manufacture for computer-vision enabled sign language to text/speech. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Artificial neural networks (ANNs) are computing systems inspired by the biological neural networks. An ANN is based on a collection of connected units or nodes called artificial neurons. An artificial neuron receives signals then processes them and can signal neurons connected to it. The “signal” at a connection is a real number, and the output of each neuron is computed by some non-linear function of the sum of its inputs. The connections are called edges. Artificial neurons and edges typically have a weight that adjusts as learning proceeds. The weight increases or decreases the strength of the signal at a connection. Neurons may have a threshold such that a signal is sent only if the aggregate signal crosses that threshold. Artificial neurons can be aggregated into layers. Different layers may perform different transformations on their inputs. Signals travel from the first layer (e.g. the input layer) to the last layer (e.g. the output layer), possibly after traversing the layers multiple times.

Convolutional neural network (CNN) is a class of artificial neural network (ANN), most commonly applied to analyze visual imagery. CNNs can utilize a shared-weight architecture of convolution kernels and/or filters that slide along input features and provide translation-equivariant responses known as feature maps.

Computer vision tasks include methods for acquiring, processing, analyzing, and understanding digital images, and extraction of high-dimensional data from the real world in order to produce numerical or symbolic information (e.g. in the forms of decisions, movement through spatial coordinates, etc.).

Ensemble learning and ensemble methods use multiple learning algorithms to obtain better predictive performance than could be obtained from any of the constituent learning algorithms alone. Unlike a statistical ensemble in statistical mechanics, which is usually infinite, a machine learning ensemble consists of only a concrete finite set of alternative models, but typically allows for much more flexible structure to exist among those alternatives.

Graphics processing unit (GPU) is a specialized electronic circuit designed to manipulate and alter memory to accelerate the creation of images in a frame buffer intended for output to a display device.

Machine learning can include the construction and study of systems that can learn from data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning.

NumPy is a library for the Python programming language, adding support for large, multi-dimensional arrays and matrices, along with a large collection of high-level mathematical functions to operate on these arrays.

Object detection is a computer technology related to computer vision and image processing that deals with detecting instances of semantic objects of a certain class (such as humans, buildings, or cars) in digital images and videos.

Python Imaging Library (PIL) is a free and open-source additional library for the Python programming language that adds support for opening, manipulating, and saving many different image file formats. It is noted that in other example embodiments, other imaging libraries can be utilized than PIL. PIL is provided by way of example. PIL can include Python Pillow image processing functionalities. Pillow offers several standard procedures for image manipulation. These include: per-pixel manipulations, masking and transparency handling, image filtering, such as blurring, contouring, smoothing, or edge finding, image enhancing, such as sharpening, adjusting brightness, contrast, or color, adding text to images and much more.

PyTorch is an open-source machine learning framework based on the Torch library, used for applications such as computer vision and natural language processing. It is noted that in other example embodiments, other machine learning frameworks can be utilized.

ResNet-50 is a convolutional neural network that is 50 layers deep. A user can load a pretrained version of the network trained on more than a million images from the ImageNet database. The pretrained network can classify images into, for example, a 1000 object categories. As a result, the network has learned rich feature representations for a wide range of images. In one example, the ResNet-50 network has an image input size of 224-by-224. A user can use classify to classify new images using the ResNet-50 model. It is noted that ResNet-50 is provided by way of example, and in other example embodiments, other convolutional neural networks and/or pretrained deep neural networks can be utilized.

Supervised learning is the machine learning task of learning a function that maps an input to an output based on example input-output pairs. Supervised learning infers a function from labeled training data consisting of a set of training examples. In supervised learning, each example is a pair consisting of an input object (e.g. a vector) and a desired output value/supervisory signal). A supervised learning algorithm analyzes the training data and produces an inferred function, which can be used for mapping new examples. An optimal scenario can allow for the algorithm to correctly determine the class labels for unseen instances. Supervised learning can use a learning algorithm to generalize from the training data to unseen situations using an inductive bias.

TensorFlow® is an open-source software library for machine learning and artificial intelligence. TensorFlow can be used across a range of tasks but has a particular focus on training and inference of deep neural networks. TensorBoard® is TensorFlow's visualization toolkit. It is noted that TensorFlow is provided by way of example and other embodiments can use other open-source software libraries for machine learning and artificial intelligence can be utilized.

Tensor Processing Unit (TPU) is an AI accelerator application-specific integrated circuit (ASIC) developed by Google specifically for neural network machine learning.

These definitions are provided by way of example and not of limitation.

### Example Systems and Methods

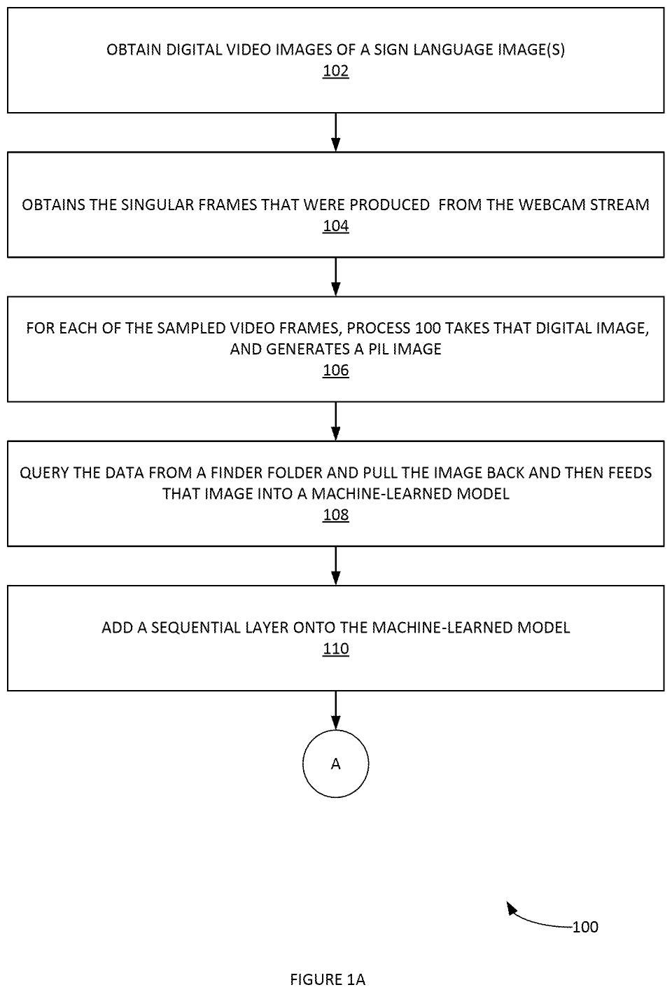

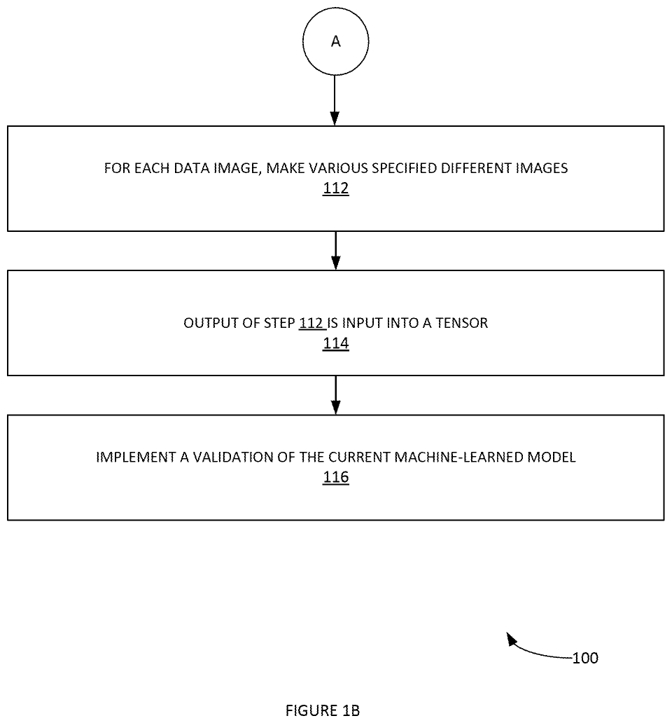

FIGS. 1A-B illustrate an example process 100 for computer vision sign language to text/speech, according to some embodiments. In step 102, process 100 can obtain digital video images of a sign language image(s). For the input, process 100 can read from a web camera (i.e a ‘webcam’) and/or other relevant video camera. A digital camera camber can be projected towards a user doing sign language. For example, a user can use a version of sign language to indicate ‘hello’ and the webcam would record the sequence of relevant digital images.

A model can then be used to interpret the content of the digital image(s). Accordingly, in step 104, from the webcam stream, process 100 obtains the singular frames that were produced. For example the video stream can be implemented at a rate of sixty (60) frames per second (FPS). Each video sample can be broken down into sixty (60) different frames. Each frame can be obtained as a singular frame and analyzed. This may be all or a subset of frames.

In one example, a subset of frames can be sampled. For example, process 100 can same one of every two or one every three frames. In this way, a 20 FPS or 30 FPS can be utilized. The rate of analyzed FPS can be correlated to the speed for compute to be utilized. If compute speed is an other, the a lower sampling rate can be automatically selected. Additionally, if a gesture is held for a period of time, then only one or two frames of that gesture are utilized for analysis.

In one example, when an application running process 100 is implemented in a CPU, then a lower number of FPS can be analyzed to save CPU processing and speed. It is noted that a GPU can be utilized when available. A GPU can be used to speed up matrix multiplication involved in video graphics processing. In other examples, process 100 can be implemented on one or more TPUs.

GPUs and TPUs are efficient for training a model or reading images from the webcam, as well as implementing subsequent analysis. That's where like GPUs and TPUs are incredibly efficient.

In step 106, for each of the sampled video frames, process 100 takes that digital image, and generates a PIL Image. Process 100 can use Pillow image formatting/functionalities. Pillow is an image format used with Python to expand and save images. The saved images can be used for training and testing the models.

The sampled video images can be saved to an on-device folder. The current frame is saved into the same folder. Process 100 can query the folder using terminal command (e.g. through Jupiter Notebook, etc.) in a completely local manner.

In this way, process 100 does not need to utilize any cloud-computing and thus, avoid additionally computer and networking latency. This also provides additionally privacy aspects.

In step 108, process 100 can query the data from a finder folder and pull the image back and then feeds that image into a machine-learned model. The machine-learned model can be a ResNet 50. The machine-learned model can be pre-trained (e.g. pulled from PyTorch and the like). The machine-learned model can have already been trained to classify various images (e.g. apples, oranges, bananas, chairs, tables, people, etc.). In this way, many of the weights of the machine-learned model can have already been set/determined during a pre-training phase. In this way, some of the model training can have been completed. This can reduce subsequent training time, as well as computer processing overhead.

In step 110, process 100 can add a sequential layer onto the machine-learned model. The sequential layer can include a linear drop models to prevent loss from increasing throughout the training process. Another linear model can be used to reduce loss down to a specified number of output classes.

The machine-learned model can now be an end module including two linear models and one activation model to prevent loss. In one example, process 100 use 1048 inputs to a number of classes.

Process 100 can be designed to prioritize speed and accuracy just due the use of mobile-device CPUs. Accuracy can be increased with more and more input data. However, speed can depend on a number of parameters in a machine-learned model. For example ResNet-50 can be utilized for being a good balance of computation speed and output accuracy.

Process 100 can use NumPy. Process 100 can use a training loader and various specified transforms.

In step 112, process 100 can, for each data image, make various different images. In this step, process 100 can resize each data image to 224 by 224 pixels. In this way, all the data images are consistent for training. The re-sized data images are then scaled down and the ends are removed. All the borders are removed. The images are then randomly flipped. The imaged can be rotated. Based on the rotation, process 100 provides more training variability. In this way, the machine-learned model can have images that are sideways and images that are crooked, etc. Accordingly, the machine-learned model is train against a greater variety of images.

Process 100 can also use various different backgrounds, different mobile device (e.g. smart phone) orientations, can be utilized in step 112 and training of the machine-learning model.

In step 114, the output of step 112 is input into a tensor (e.g. a tensor type as a multidimensional array data type). This can be used by PyTorch (and/or a similar type of ML training functionality/library) to train the models.

In step 116, process 100 can implement a validation of the current machine-learned model. Images of signs can be obtained from a validation folder. In this step, a value of the performance of the current machine-learned model on non-trained sign images (e.g. images of a person signing with their hands/arms, etc.) can be implemented. Step 116 can be used to determine how well the current machine-learned model generalizes to a population. Data loaders can be utilized. In one example, process 100 can use thirty-two (32) images at a time and one CPU. A validation can be performed for each types of sign to be recognized by the machine-learned model. For example, a ‘hello’ sign can be recognized. In one example, seven different parameters can be analyzed and a probability of the identity of a sign in the frame, is output by the process 100.

Once the machine-learning model is trained and validated, it can be sent to the CPU for access by an application computer vision application. The machine-learning model now includes a linear model, an activation function, the other linear model. The machine-learning model converts from 2048 inputs all the way down to a number of classes. In one example, this can be seven parameters that are used to provide an output probability.

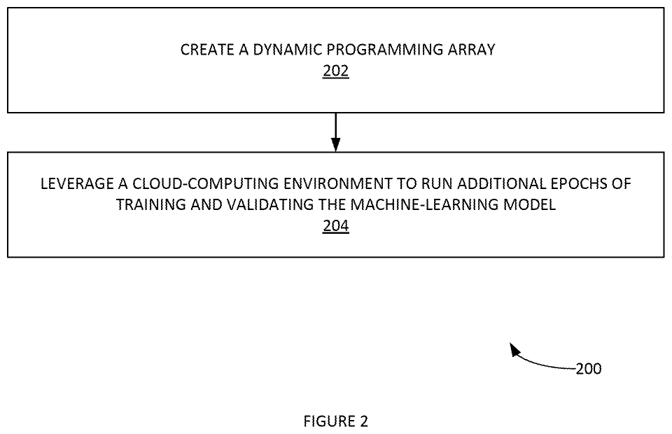

FIG. 2 illustrates an example process 200 for using dynamic programming to optimize the machine-learning model, according to some embodiments. The machine-learning model can be generated by process 100. Process 200 can use dynamic programming to optimize machine-learning model. This can be done to decrease computational expense even further.

Process 200 can determine possibilities of each signed word. This can be done based on the sentence formation. For example, when a sentence is being signed process 200 can use information theory to determine a probability of subsequent signed words/phrases.

In step 202, process 200 create a dynamic programming array. The dynamic programming array enables multiple base cases. Each base case can represent certain types of probabilities of a sentence stem forming and growing. In this way, process 200 can avoid use of recursive methods that go back and forth in a repetitive manner. In this, way, process 200 can minimize computations. Additionally, that the data structures of dynamic programming arrays can be less expensive in terms of memory as well as there can be fewer states for in a dynamic programming array.

Process 200 can also be used to optimize training expenses (e.g. in terms of time and processor use). It is noted that an epoch of training the machine-learning model and then validating said model can be performed locally. In step 204, process 200 can leverage a cloud-computing environment (e.g. Jupyter Notebook, Google Colaboratory, etc.) that runs in the cloud and stores its notebooks on cloud-base file storage system (e.g. Google Drive®, etc.). to run additional epochs of training and validating the machine-learning model. For example, the training and validation functions can be run thousands of epochs in GPUs available (e.g. via Google Colab®, etc.). The increased training can improve the model's accuracy.

In some examples, process 200 can limit the amount of possibilities (e.g. limit the set of available signed words) available for the model to interpret. This can also reduce computation costs.

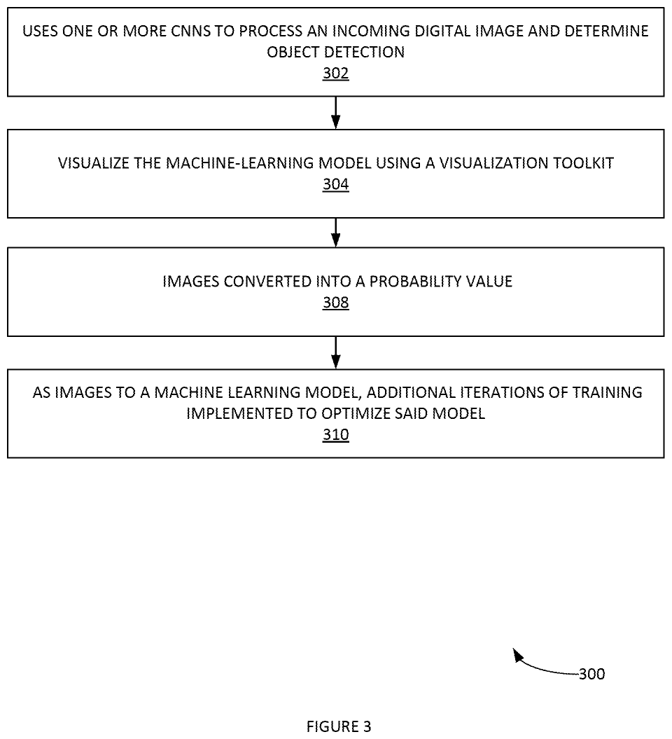

FIG. 3 illustrates an example process 300 for computer vision operations, according to some embodiments. In step 302, process 300 uses one or more Convolution Neural Networks (CNNs) to process an incoming digital image and determine object detection. So anything has to do with OpenCV, which is essentially computer vision. The CNNs can be used to determine/find a hand in the digital image. In this way, process 300 does not need to implement object detection or image segmentation (e.g. as these can increase both process time, etc.).

In step 304, process 300 can visualize the machine-learning model using a visualization toolkit (e.g. TensorBoard, etc.). The visualization can use code cells. The visualization can show, inter alia: where the data goes through the machine-learning model, what the weights and biases are, where weights and biases are, etc. In this way, a developer can see which elements of the machine learning model are trainable and which are not trainable. Developers can determine various parameters correctly. In one example embodiment, data visualization can be implemented (e.g. using Matplotlib, etc.) by plotting the relevant of the different images from the training dataset. It is noted that color can be removed from the digital images.

Input image(s) can be scaled or shrunken with a data transformer. As noted supra, it can be resized and horizontally flipped, scaled, etc. A set of individual images can be passed into the model and trained.

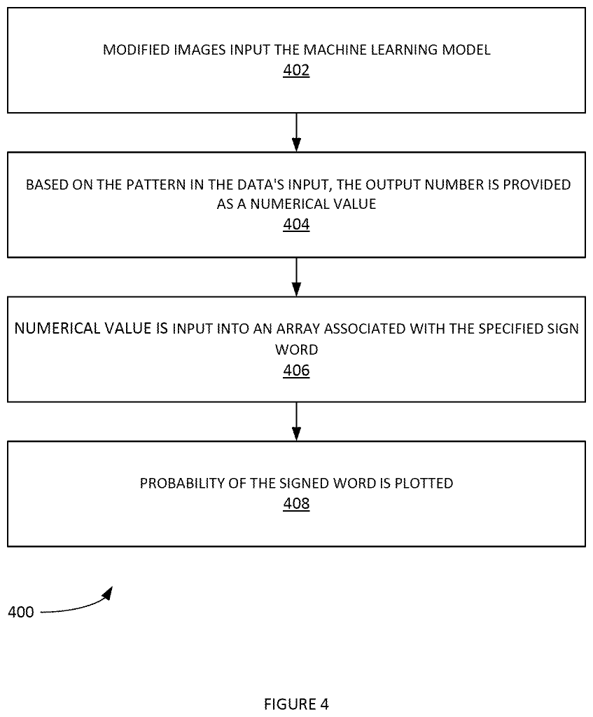

The classes can be plotted and images can be converted into a probability value in step 306. For example, FIG. 4 illustrates an example process 400 for converting modified digital image(s) into a probability value that the images represent a specified sign, according to some embodiments. In step 402, the modified images can be input the machine learning model (e.g. ResNet model). Based on the pattern in the data's input, the output number is provided as a numerical value in step 404. This is then input into an array associated with the specified sign word in step 406. The array is equated to a predicted signed word to be stored. The probability of the signed word is provided by the array. The probability of the signed word can be plotted in step 408.

Returning to process 300, as images to a machine learning model, additional iterations of training can be implemented to optimize said model in step 310. Large batches of images can be trained in this way. Final training adjustments can be implemented on the machine learning models so that an entire model is not trained over and over again.

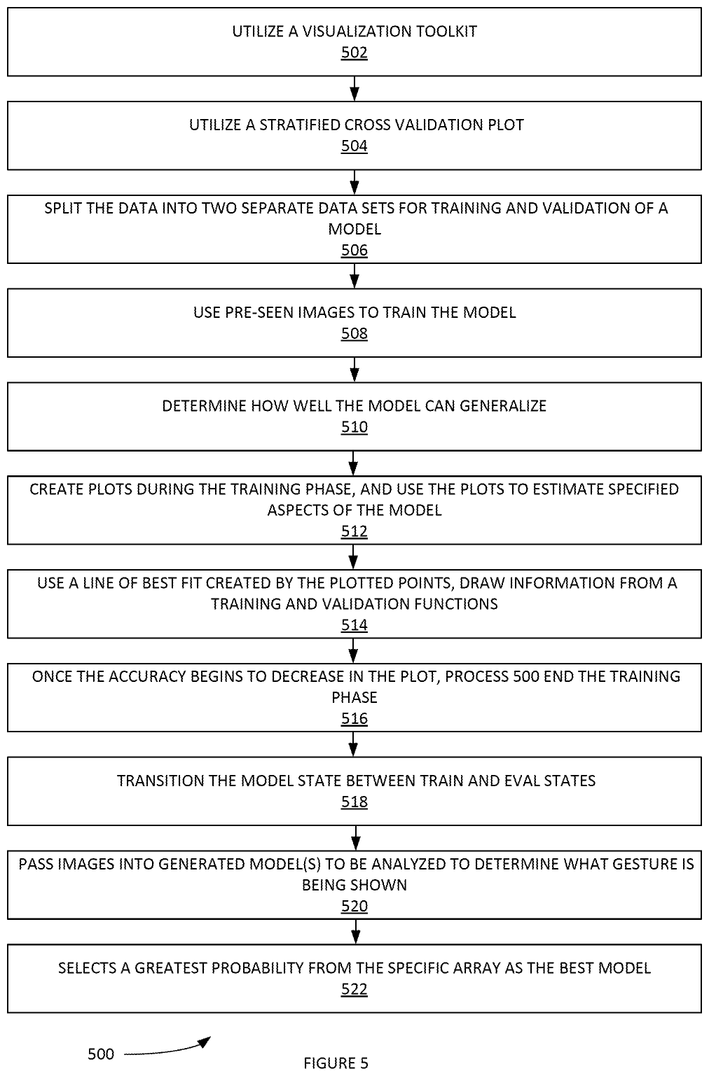

FIG. 5 illustrates an example processing of utilizing plots to show the improvement in the accuracy of a machine learning mode over time, according to some embodiments. In step 502, process 500 can utilize a visualization toolkit. For example, process 500 can use a Tensorboard® (and/or any other visualization toolkit, etc.) as it allows us to directly pull the information/data from our model during training and plot it in real-time.

Process 500 can use two types of plots: a training plot and a cross-validation plot. In the present example, in step 504, process 500 can utilize a stratified cross validation plot. Using stratified cross validation techniques can enable process 500 to split the data into two separate data sets (e.g. one for training and one for validation) in step 506. In one example, process 500 can use a stratified sampling in cross-validation. In another example, process 500 can use a k fold cross validation. Process 500 can use stratified sampling in cross-validation to ensure the training and test sets have the same proportion of the feature of interest as in the original dataset. Stratified sampling in cross-validation with a target variable can ensure that the cross-validation result is a close approximation of generalization error.

One set contains images the model's seen before, and what the model uses to learn (e.g. training set) in step 508. Another other dataset contains images that have not yet been analyzed by the model (e.g. validation set), which can then be used to determine how well the model can generalize (e.g. perform in real-life situations) in step 510. Use of the plots can be use to avoid overfitting during training and validation.

In step 512, process 500 can create plots during the training phase, and use the plots to estimate specified aspects of the model, inter alia: the trend over time, how accurate is our model going to be, and whether an overfit is being generated with a model. In step 514, process 500 can use a line of best fit created by the plotted points, and can draw information from a training and validation functions.

Process 500 can use an asymptotes approach to signal a current accuracy. Process 500 can be use to determine when the training phase of the model should be stopped. It is noted that the validation plots can be implemented in TensorBoard and a line of best fit can be generated. In step 516, once the accuracy begins to decrease in the plot, process 500 can end the training phase. This can keep the accuracy as high as possible in the validation set, while ensuring that we do not lose our ability to generalize to real-world scenarios by overfitting.

Process 500 can transition the model state between train and eval states in step 518. These two states allow process 500 to control when the model can make a prediction and learn from an image and/or make a prediction about what it thinks an image represents. The train state allows the model to both make a prediction and learn how to improve its accuracy using gradient descent. It is noted that gradient descent essentially is a process that allows the model to tune the weights and biases which affect the decisions it makes. As these weights and biases are tuned more and more through training, the predictions of the model become more accurate. The other state is the evaluation (e.g. eval state). In the eval state, the model is not allowed to perform gradient descent, meaning that it cannot learn about the images it sees, emulating its usage in real life and allowing us to observe how it would truly perform. For each of the images process 500 uses, it opens the image using Pillow and/or other package that allows process 500 to open images that can be fed into machine learning models such as convolutional neural networks. For example, process 500 can use a “pil.image.open” function.

In step 520, process 500 can pass these opened images into the generated model(s) to be preprocessed and then be analyzed to determine what gesture is being shown. As noted supra, the output of step 520 is an array of probabilities. In step 522, process 500 selects a greatest probability from the specific array as the best model made regarding what gesture was being shown in the image.

Process 500 can use various preprocessing methods (e.g. as discussed supra) coupled with the sequential layers on top of a set of convolutional neural network models to increase accuracy while recognizing gestures.

In one example, to display the image and an output in a more user-friendly way, process 500 can generate a frame (e.g. a new pop-up in a browser). Within this popup, process 500 can display the image that being processed (e.g. the image with the gesture) and the interpreted meaning of that gesture (e.g. how, what, a, b, c, d, etc.). Throughout process 500, a while loop can be run that displays what the camera is able to see, and alongside it, the gesture shown. The same image being displayed in the popup frame is what process 500 is then presently analyzing. In this way, a user can what the model is predicting in real-time (e.g. assuming processing and network latencies, etc.).

Various application extensions and plugins can be built using the processes described herein. These can be integrated into Web-conferencing applications (e.g. Zoom®, Google Meet®, other video-communication services, etc.). In this way, sign language words and phrases can be converted to text and/or synthetic speech in real time (e.g. assuming networking and processing latencies).

### Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States Patent:

1. A method for converting a digital image comprising a sign-language sign to a text or computer-generated speech:
obtaining a web camera stream of a sign-language sign;
breaking down the one or more digital video images into a set of singular frames;
for each singular frame of the set of singular frames, convert the digital image in the singular frame to an imaging library image;
providing a machine-learned model;
feeding the digital image into the machine-learned model;
adding a sequential layer onto the machine-learned model, wherein the sequential layer comprises a first linear drop model to prevent loss from increasing throughout a training process, and wherein the sequential layer comprises a second linear model used to reduce a loss down to a specified number of output classes;
for each digital image:
resizing the digital image to two-hundred and twenty-four (224) by two-hundred and twenty-four (224) pixels,
scaling down the digital image,
removing each border of the digital image, and
randomly rotating the digital image to create a modified digital image;
inputting the modified digital image input into a tensor; and
using the tensor to train the machine-learning model to recognize the sign-language sign.

2. The method of claim 1 further comprising:
implementing a validation operation of the machine-learned model.

3. The method of claim 1, wherein the a set of singular frames are obtained from the from a web camera stream at a rate of sixty (60) frames per second (FPS).

4. The method of claim 1, wherein the machine-learned model comprises a ResNet 50 machine-learned model.

5. The method of claim 1, wherein the machine-learned model has been pre-trained to classify a specified set of objects.

6. The method of claim 1, wherein the sequential layer comprises an activation model to prevent a specified loss.

7. The method of claim 1 further comprising:
using a dynamic programming technique to optimize machine-learning model. This can be done to decrease computational expense even further.

8. The method of claim 7, wherein the dynamic programming technique comprises:
based on a current sentence formation of determine possibilities of a subsequent signed word.

9. The method of claim 1, wherein the imaging library comprises a Python Imaging Library (PIL).

10. A server system for converting a digital image comprising a sign-language sign to a text or computer-generated speech comprising:
at least one processor configured to execute instructions;
a memory containing instructions when executed on the processor, causes the at least one processor to perform operations that:
obtain a web camera stream of a sign-language sign;
break down the one or more digital video images into a set of singular frames;
for each singular frame of the set of singular frames, convert the digital image in the singular frame to an imaging library image;
provide a machine-learned model;
feed the digital image into the machine-learned model;
add a sequential layer onto the machine-learned model, wherein the sequential layer comprises a first linear drop model to prevent loss from increasing throughout a training process, and wherein the sequential layer comprises a second linear model used to reduce a loss down to a specified number of output classes;
for each digital image:
resize the digital image to two-hundred and twenty-four (224) by two-hundred and twenty-four (224) pixels,
scale down the digital image,
remove each border of the digital image, and
randomly rotate the digital image to create a modified digital image;
input the modified digital image input into a tensor; and
use the tensor to train the machine-learning model to recognize the sign-language sign.
